(19) United States
(12) Patent Application Publication
(10) Pub. No.: US 2024/0073967 A1
(43) Pub. Date: Feb. 29, 2024

(54) Managing Pending Data in Inactive State Scenarios

(71) Applicant: GOOGLE LLC, Mountain View, CA (US)

(72) Inventor: Shiangrung Ye, Sanchong District, New Taipei City (TW)

(21) Appl. No.: 18/261,477

(22) PCT Filed: Jan. 7, 2022
(86) PCT No.: PCT/US22/11537

§ 371 Date: Jul. 13, 2023

Related U.S. Application Data
(60) Provisional application No. 63/199,634, filed on Jan. 13, 2021.

(51) Int. Cl. H04W 74/08; H04W 72/1268; H04W 76/20

(52) U.S. Cl. CPC H04W 74/0875; H04W 72/1268; H04W 74/0833; H04W 76/20

(57) ABSTRACT

A method in a UE for communicating with a base station when the UE operates (702) in an inactive state associated with a protocol for controlling radio resources is disclosed. The UE is configured (i) to transmit data for a first channel using a first procedure that causes the UE to transition to a connected state associated with the protocol and (ii) to transmit data for a second channel using a second procedure that does not cause the UE to transition to the connected state. The method includes detecting (704) pending data addressed to the base station, the pending data including first data for the first channel and second data for the second channel. The method further includes selecting (706) the first procedure or the second procedure based on comparing a priority of the first channel to a priority of the second channel and transmitting (708) at least a portion of the pending data using the selected procedure.

### FIELD OF THE DISCLOSURE

This disclosure relates to wireless communications and, more particularly, to techniques for managing small data transmission (SDT).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

UEs can use several types of SRBs and DRBs. When operating in dual connectivity (DC), the cells associated with the base station operating as the master node (MN) define a master cell group (MCG), and the cells associated with the base station operating as the secondary node (SN) define the secondary cell group (SCG). So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MCG but using the lower-layer resources of the MN, the SN, or both the MN and the SN can be referred to as split DRBs.

The UE in some scenarios can concurrently utilize resources of multiple nodes (e.g., base stations or components of a distributed base station) of a radio access network (RAN), interconnected by a backhaul. In these scenarios, the UE is considered to be operating in multi-connectivity (MC) with the multiple nodes. For example, when the UE concurrently utilizes resources of two network nodes, the UE is considered to be operating in dual connectivity with the two network nodes. When these network nodes support different radio access technologies (RATs), such as 5G NR and EUTRA, this type of connectivity is referred to as Multi-Radio Dual Connectivity (MR-DC). When a UE operates in MR-DC, one base station operates as the MN that covers a primary cell (PCell), and the other base station operates as the SN that covers a primary secondary cell (PSCell). The UE communicates with the MN (via the PCell) and the SN (via the PSCell). In other scenarios, the UE utilizes resources of one base station at a time. One base station and/or the UE determines that the UE should establish a radio connection with another base station. For example, one base station can determine to hand the UE over to the second base station, and initiate a handover procedure. The UE in other scenarios can concurrently utilize resources of a RAN node (e.g., a single base station or a component of a distributed base station), interconnected to other network elements by a backhaul.

The MN can provide a control-plane connection and a user-plane connection to a core network (CN), whereas the SN generally provides a user-plane connection. A base station (e.g., MN, SN) and/or the CN in some cases causes the UE to transition from one state of the RRC protocol to another state. More particularly, the UE can operate in an idle state (e.g., EUTRA-RRC_IDLE, NR-RRC IDLE), in which the UE does not have a radio connection with a base station; a connected state (e.g., EUTRA-RRC_CONNECTED, NR-RRC CONNECTED), in which the UE has a radio connection with the base station; or an inactive state (e.g., EUTRA-RRC INACTIVE, NR-RRC INACTIVE), in which the UE has a suspended radio connection with the base station.

By operating in the inactive state, the UE can save power in comparison to the connected state. Because the UE suspends the radio connection instead of releasing the radio connection, the UE can quickly resume the radio connection to communicate with a base station. Further, certain recently introduced techniques such as early data transmission and small data transmission (SDT) allow the UE to transmit data while operating in the inactive state. Both configured grant (CG)-based SDT and random access (RA)-based SDT schemes generally allow the UE to communicate with the base station during the inactive state. Alternatively, the UE can transmit data by transitioning to the connected state, such as by performing a legacy random access procedure to resume the radio connection.

A base station can configure the UE to perform SDT on a per-channel basis. Thus, based on a channel configuration for a channel, such as a logical channel or a DRB, the UE determines whether to transmit pending data for the channel using SDT or a legacy procedure. However, it is not clear how the UE should transmit pending data when the UE simultaneously has pending data for multiple, differently-configured channels.

### SUMMARY

A UE operating in an inactive state can implement the techniques of this disclosure to select a procedure for transmitting pending data when the pending data includes data for differently-configured channels. Initially, the UE can receive from a base station configurations for multiple channels. Each configuration indicates (i) a priority of the respective channel and (ii) whether data for the respective channel is to be transmitted using a first procedure that causes the UE to enter the connected state (e.g., a legacy RA procedure), or using a second procedure that does not cause the UE to enter the connected state (e.g., SDT).

If the UE detects pending data for two channels, the UE can select which procedure to utilize for transmitting the pending data based on the relative priorities of the two channels. If the priority of one channel is above the priority of the other channel, then the UE can select the procedure associated with the higher-priority channel to transmit the data for that channel. If the priorities of the two channels are the same, the UE can prioritize transmitting the data for the channel associated with the second procedure.

If the UE selects the second procedure, the UE may further need to select a type of SDT to utilize. The UE can check whether the UE has been configured with a CG for the time resources corresponding to the next transmission opportunity. If so, the UE can utilize the CG to transmit the pending data for the second channel. Otherwise, the UE can either perform RA-based SDT, or can wait until a later transmission opportunity for which the UE does have a CG.

The UE can specify to the base station whether the UE is performing RA-based SDT or a legacy RA procedure when the UE initiates the RA procedure. The base station allocates different RA resources (i.e., different preambles and/or different physical RA channel (PRACH) occasions) for RA-based SDT and legacy RA procedures. To indicate whether the UE has selected RA-based SDT or a legacy RA, the UE uses the RA resources corresponding to the selected procedure.

Further, in some implementations, a UE detects a medium access control (MAC) control element (CE) for transmission to the base station, but does not detect pending data. In response, the UE can utilize SDT to transmit the MAC CE.

One example embodiment of these techniques is a method implemented in a UE for communicating with a base station when the UE operates in an inactive state associated with a protocol for controlling radio resources, the UE configured (i) to transmit data for a first channel using a first procedure that causes the UE to transition to a connected state associated with the protocol and (ii) to transmit data for a second channel using a second procedure that does not cause the UE to transition to the connected state. The method can be executed by processing hardware and includes detecting pending data addressed to the base station, the pending data including first data for the first channel and second data for the second channel. The method further includes selecting the first procedure or the second procedure based on comparing a priority of the first channel to a priority of the second channel, and transmitting, by the processing hardware, at least a portion of the pending data using the selected procedure.

Another example embodiment of these techniques is a UE including processing hardware and configured to implement the method above.

### BRIEF DESCRIPTION OF THE DRAWINGS

FIG. 1 is a block diagram of an example system in which a base station of a radio access network (RAN) and a user equipment (UE) can implement the techniques of this disclosure for transmitting data when operating in an inactive state;

FIG. 2 is a block diagram of an example protocol stack according to which the UE of FIG. 1 communicates with base stations;

FIG. 3A is a messaging diagram of an example scenario in which a UE operating in the inactive mode detects uplink data for a first channel and a second channel, where the UE is configured to transmit data for the second channel using small data transmission (SDT) and to transmit data for the first channel using a non-SDT procedure, and where the UE determines to use SDT based on the relative priorities of the first and second channels;

FIG. 3B is messaging diagram of an example scenario similar to the scenario of FIG. 3A, where the UE determines to use configured grant (CG)-based SDT;

FIG. 3C is a messaging diagram of an example scenario similar to the scenario of FIG. 3A, where the UE determines to wait for a next-available CG in order to use CG-based SDT;

FIG. 3D is a messaging diagram of an example scenario similar to the scenario of FIG. 3A, where the UE determines to use random access (RA)-based SDT;

FIG. 4 is a messaging diagram of an example scenario similar to the scenario of FIG. 3A, but where the UE determines to use SDT based on the priorities of the first and second channels being the same;

FIG. 5 is a flow diagram of an example method for transmitting a medium access control (MAC) control element (CE) when operating in the inactive mode, which can be implemented by a UE of this disclosure;

FIG. 6 is a flow diagram of an example method for transitioning from an RA-based SDT to a legacy RA procedure when operating in the inactive mode, which can be implemented by a UE of this disclosure; and

FIG. 7 is a flow diagram of an example method for communicating with a base station when operating in the inactive mode, which can be implemented by a UE of this disclosure.

### DETAILED DESCRIPTION OF THE DRAWINGS

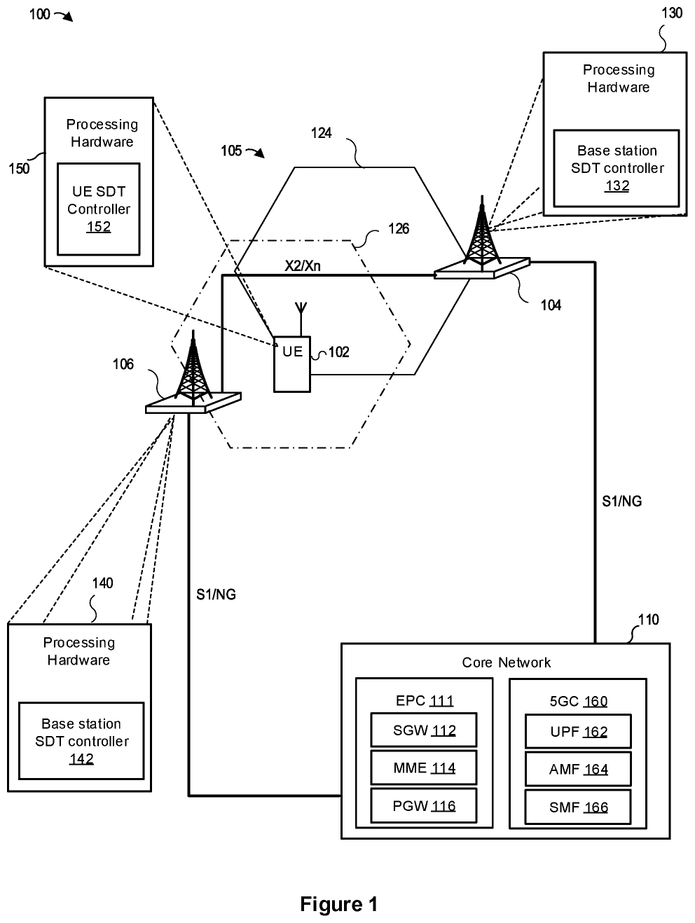

FIG. 1 depicts an example wireless communication system 100 that can implement the techniques of this disclosure. The wireless communication system 100 includes a UE 102, a base station 104, a base station 106, and a core network (CN) 110. The techniques of this disclosure can be implemented in the UE 102 or in one or both of the base stations 104 and 106.

The base stations 104 and 106 can be any suitable type, or types, of base stations, such as an evolved node B (eNB), a next-generation eNB (ng-eNB), or a 5G Node B (gNB), for example. The UE 102 can communication with the base station 104 and the base station 106 via the same radio access technology (RAT), such as EUTRA or NR, or different RATs. The base station 104 supports a cell 124, the base station 106 supports a cell 126. The cell 124 partially overlaps with the cell 126, such that the UE 102 can be in range to communicate with base station 104 while simultaneously being in range to communicate with the base station 106 (or in range to detect or measure the signal from the base station 106). The overlap can make it possible for the UE 102 to hand over between cells (e.g., from the cell 124 to the cell 126) or base stations (e.g., from the base station 104 to the base station 106). As another example, the UE 102 can communicate in dual connectivity (DC) with the base station 104 (operating as an MN) and the base station 106 (operating as an SN).

The base stations 104 and 106 operate in a radio access network (RAN) 105 connected to the CN 110, which can be an evolved packet core (EPC) 111 or a fifth-generation core (5GC) 160. The base station 104 can be implemented as an eNB supporting an S1 interface for communicating with the EPC 111, an ng-eNB supporting an NG interface for communicating with the 5GC 160, or as a gNB that supports the NR radio interface as well as an NG interface for communicating with the 5GC 160. The base station 106 can be implemented as an eNB with an S1 interface to the EPC 111, an ng-eNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 104 and 106 can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

With continued reference to FIG. 1, the base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation in FIG. 1 includes a base station SDT controller 132 that is configured to support the techniques of this disclosure, discussed below. Similarly, the base station 106 is equipped with processing hardware 140 and a base station SDT controller 142, which are similar to the processing hardware 130 and the SDT controller 132, respectively.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1 includes a UE SDT controller 152 that is configured to support the techniques of this disclosure, discussed below.

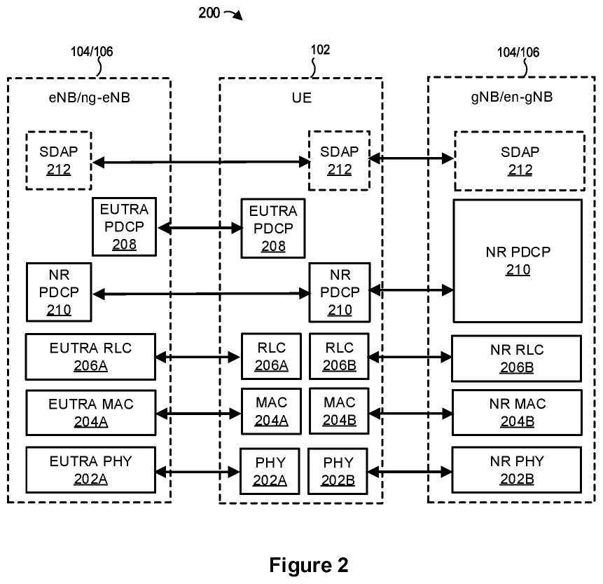

Next, FIG. 2 illustrates, in a simplified manner, an example protocol stack 200 according to which the UE 102 can communicate with an eNB/ng-eNB or a gNB (e.g., one or both of the base stations 104 and 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

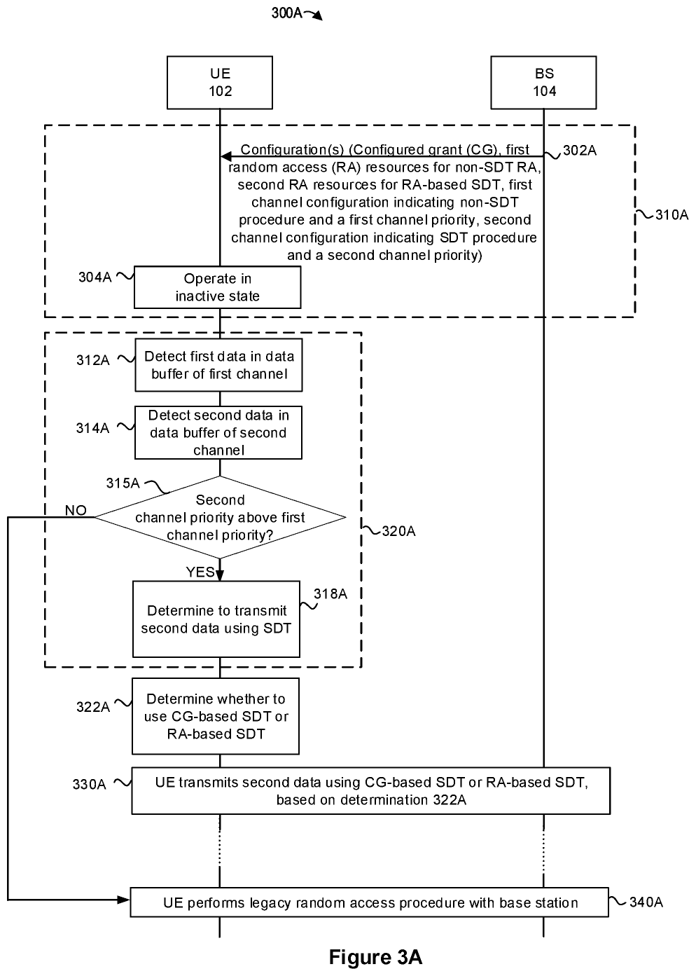

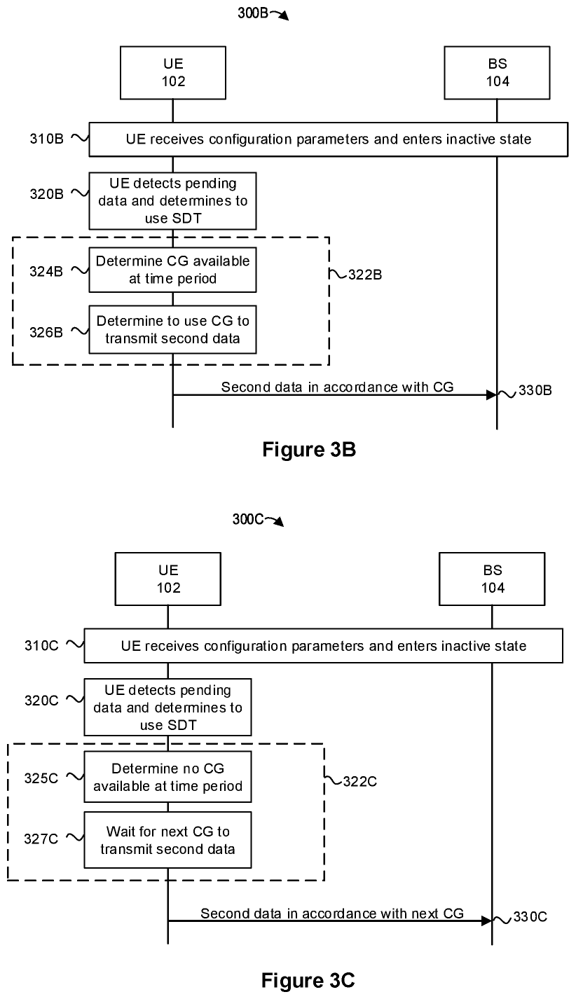

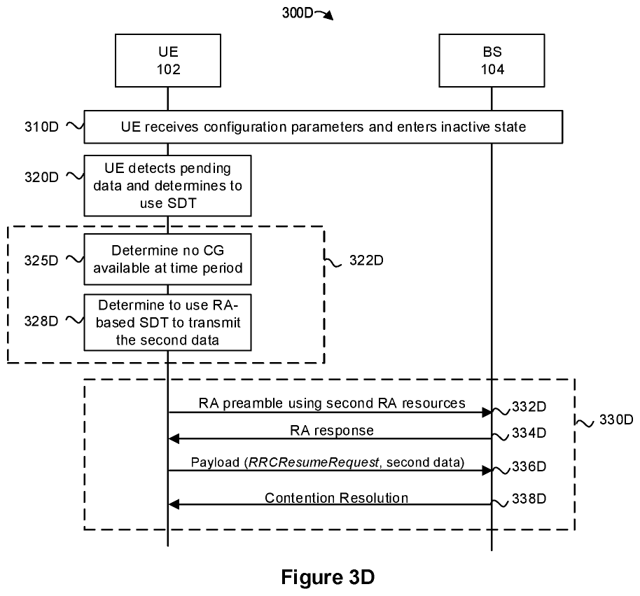

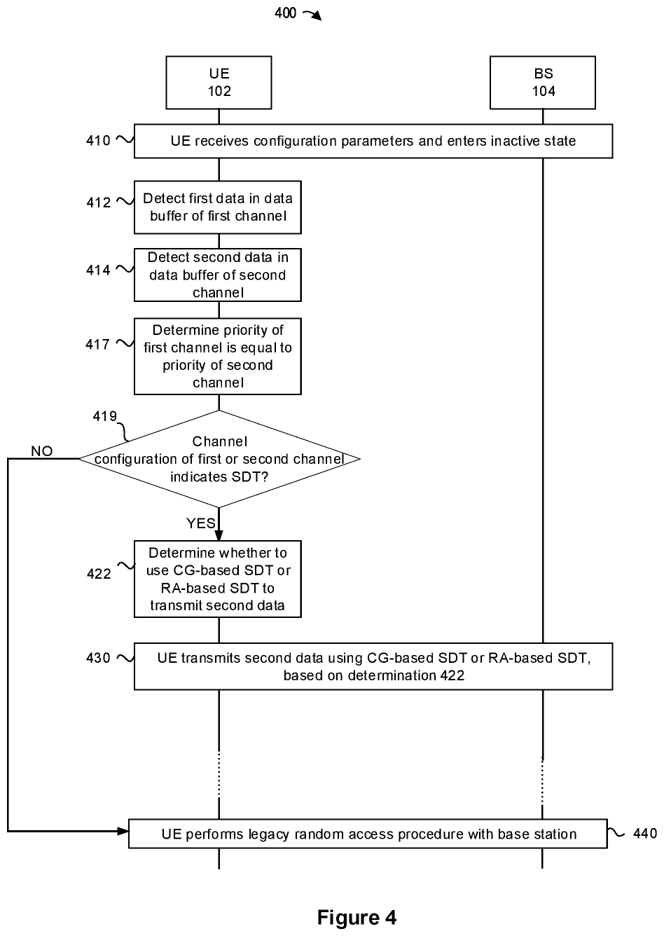

FIGS. 3A-4 are messaging diagrams of example scenarios in which a base station and UE implement the techniques of this disclosure for managing pending data during in inactive mode scenarios. Generally speaking, events in FIGS. 3A-4 that are similar are labeled with similar reference numbers (e.g., event 310A is similar to events 310B, 310C, 310D, and 410) with differences discussed below where appropriate. With the exception of the differences shown in the figures and discussed below, any of the alternative implementations discussed with respect to a particular event (e.g., for messaging and processing) may apply to events labeled with similar reference numbers in other figures.

Turning first to FIG. 3A, a UE 102 communicates with a base station 104 during a scenario 300A. Initially, the base station 104 transmits 302A a configuration message to the UE 102. The information included in the configuration message can vary depending on implementation. The configuration message at least includes one or more configured grants (CGs). A CG includes a radio resource configuration for a scheduled uplink transmission (e.g., time and/or frequency resources, periodicity, etc.). Each CG also may be associated with a beam, i.e., a spatial configuration.

The configuration message also includes random access (RA) resources for the UE 102 to utilize to initiate a random access procedure with the base station 104. The random access resources may include one or both of (a) a first type of random access resources for performing legacy random access procedures (i.e., non-SDT random access procedures) and (b) a second type of random access resources for performing RA-based SDT. The first type of random access resources include random access preambles and/or Physical Random Access Channel (PRACH) occasions for performing legacy random access procedures, which cause the UE 102 to transition to the connected state. A PRACH occasion is an occasion on which the UE 102 can transmit a random access preamble to initiate a random access procedure. The second type of random access resources include random access preambles and/or PRACH occasions that are dedicated for use in the inactive state. In particular, the RA preambles and/or PRACH occasions may be dedicated for performing RA-based SDT, which does not cause the UE 102 to transition to the connected state.

The configuration message further includes configurations for two or more channels, including at least a first channel configuration for a first channel and a second channel configuration for a second channel. The first channel configuration indicates that data for the first channel should be transmitted using a non-SDT procedure (e.g., a legacy random access procedure) and indicates a first channel priority. Likewise, the second channel configuration indicates that data for the second channel should be transmitted using an SDT procedure and indicates a second channel priority.

After or in response to the configuration message, the UE 102 begins 304A to operate in an inactive state. For example, the configuration message may be an RRC message that causes the UE 102 to transition to an inactive state, such as an RRCRelease message or an RRCReject message. While the event 304A refers to the UE 102 transitioning to an inactive state (e.g., RRC_INACTIVE), alternatively the UE 102 can transition to another state in which a UE does not have an active radio connection, such as an idle state (e.g., RRC_IDLE) with a suspended radio connection. The embodiments of this disclosure in general apply to an idle state with a suspended radio connection as well as to an inactive state. The events 302A and 304A are collectively referred to in this disclosure as an inactive state initiation procedure 310A.

Next, the UE 102 detects 312A first data for the first channel and detects 314A second data for the second channel. For example, the UE 102 can detect 312A first data in a data buffer of the first channel and detect 314A second data in a data buffer of the second channel. The UE 102 therefore has pending data including both the first and second data. To determine which procedure to use to transmit the pending data, the UE 102 determines 315A whether the second channel priority is above the first channel priority. If the second channel priority is above the first channel priority, then the UE 102 determines 318A to transmit the second data using an SDT procedure. At a later time, the UE 102 can transmit the first data using a legacy random access procedure. However, because (i) the second channel priority is above the first channel priority and (ii) the second data for the second channel can be transmitted via SDT, the UE 102 prioritizes transmitting the second data using SDT.

If the second channel priority is below the first channel priority, then the UE 102 performs 340A a legacy random access procedure in order to transmit the pending data. The UE 102 can transmit the pending data during the legacy random access procedure, and transition to the connected state after or in response to the legacy random access procedure. The legacy random access procedure can be a four- or two-step random access procedure. When initiating the legacy random access procedure, the UE 102 uses random access resources (i.e., a random access preamble or a PRACH occasion) included in the first type of random access resources discussed above with reference to event 302A. In the event that the second channel priority and the first channel priority are the same, the UE 102 can implement the techniques discussed below with reference to FIG. 4.

The events 312A, 314A, 315A (in particular, the “YES” branch of 315A), and 318A are collectively referred to in this disclosure as an SDT selection procedure 320A. After determining 318A to transmit the second data using SDT, the UE 102 can determine 322A whether to use CG-based SDT or RA-based SDT, discussed in more detail with reference to FIGS. 3B-3D. The UE 102 can then transmit 330A the second data using either CG-based SDT or RA-based SDT, depending on the outcome of the determination 322A. While the UE 102 detects pending data for two channels in the scenario 300A, in other implementations, the UE 102 can detect pending data for more than two channels. In response, the UE 102 can apply similar techniques as those described for the scenario 300A. In particular, to transmit the pending data, the UE 102 can select the procedure associated with the highest-priority channel. For example, if there are three channels, and the highest priority channel is associated with an SDT procedure, then the UE 102 can select the SDT procedure to transmit the pending data for that highest priority channel.

In another embodiment, not illustrated in FIG. 3A, the UE 102 may compare the total volume of pending data to a threshold for SDT prior to comparing the priorities of the first and second channels. In order to transmit data via SDT, the volume of data should be below a threshold, where the threshold can be pre-configured at the UE 102 or configured at the UE 102 by the base station 104. In an embodiment, the UE 102 compares the total volume of pending data (i.e., the first data and the second data) to the threshold before comparing 315A the channel priorities. If the total volume is above the threshold, then the UE 102 can perform 340A the legacy random access procedure to transmit the pending data. If the total volume is below the threshold, then the UE 102 can compare 315A the channel priorities and continue to perform the steps illustrated in the scenario 300A. If the UE 102 compares 315A the channel priorities and determines 318A to transmit the second data using SDT, the UE 102 may compare the volume of the second data to the threshold. If the volume of the second data is above the threshold, then the UE 102 can perform 340A the legacy random access procedure. If the volume of the second data is below the threshold, then the UE 102 transmits 330A the second data using either CG-based or RA-based SDT.

FIG. 3B illustrates a scenario 300B, similar to the scenario 300A, where the UE 102 determines 322B to use CG-based SDT. Events 310B and 320B are similar to the events 310A and 320A, respectively. After determining 320B to utilize SDT to transmit the second data, the UE 102 determines 324B that the UE 102 has been configured with a CG for a time period. The UE 102 can receive CGs in the configuration message during the inactive state initiation procedure 310B. The time period can refer to the next frame, subframe, or slot at which the UE 102 can perform a transmission, which may correspond to the remaining portion of a current frame or subframe, or a subsequent frame or subframe. Thus, the UE 102 determines 324B that the UE 102 has a CG at time resources corresponding to the next transmission opportunity. The UE 102 then determines 326B to use the CG to transmit the second data. Accordingly, the UE 102 transmits 330B the second data in accordance with the CG. The message that the UE 102 transmits 330B can be, for example, an RRC message such as an RRCResurneRequest or an RRCSetupRequest.

FIG. 3C illustrates a scenario 300C, similar to the scenario 300A, where the UE 102 determines 322C to use CG-based SDT. Events 310C and 320C are similar to the events 310A and 320A, respectively. After determining 320C to utilize SDT to transmit the second data, the UE 102 determines 325C that the UE 102 has not been configured with a CG for a time period (i.e., for time resources corresponding to the next transmission opportunity). However, the UE 102 may be configured with CGs corresponding to time resources after the time period. Thus, in response to the determination 325C, the UE 102 can determine 327C to wait to transmit the second data until a later transmission opportunity when the UE has a CG available. For example, the UE 102 can have a CG configured for a later time period after the time period. The UE 102 then transmits 330C the second data in accordance with this later-available CG.

Alternatively, if the UE 102 determines that the UE 102 has not configured with a CG for a time period, the UE 102 can apply the techniques illustrated in FIG. 3D. In the scenario 300D, the UE 102 determines 322D to use RA-based SDT. Events 310D and 320D are similar to the events 310A and 320A, respectively. Similar to the scenario 300C, the UE 102 determines 325D that the UE 102 has not been configured with a CG for a time period. However, instead of performing CG-based SDT, the UE 102 determines 328D to use RA-based SDT to transmit the second data. The UE 102 then performs 330D an SDT random access procedure to transmit the second data.

To transmit the second data, the UE 102 can utilize a four-step random access procedure, as illustrated by FIG. 3D, or a two-step random access procedure. The UE 102 initiates the four-step random access procedure by transmitting 332D a random access preamble using the second type of random access resources discussed above with reference to event 302A. The base station 104 responds by transmitting 334D a random access response (RAR) to the UE 102. After receiving the RAR, the UE 102 transmits 336D a payload including the second data to the base station. The payload, for example, can include an RRCResurneRequest message or an RRCSetupRequest message. The UE 102 can transmit the payload on the Physical Uplink Shared Channel (PUSCH). In response to receiving the payload, the base station 104 transmits 338D a contention resolution to the UE 102.

The events 332D, 334D, 336D, and 338D collectively make up a four-step random access procedure, where the events may be, respectively, respectively, “Msg1,” “Msg2,” “Msg3,” and “Msg4” of the four-step random access procedure. Alternatively, the UE 102 can perform a two-step random access procedure to transmit the second data. The UE 102 can transmit both the random access preamble and the payload in a “MsgA” of the two-step random access procedure. The random access preamble and the payload are two parts of the MsgA that are sent at different occasions: the UE 102 transmits the random access preamble via a PRACH occasion (e.g., similar to Msg1 of the four-step random access procedure), and the UE 102 transmits the payload via a PUSCH occasion (e.g., similar to Msg3 of the four-step random access procedure). In response to the MsgA, the base station 104 transmits a “MsgB” including a contention resolution and a RAR to the UE 102.

Turning to FIG. 4, a scenario 400 is similar to the scenario 300A, but the UE 102 determines that the first and second channel priorities are the same. In particular, the events 410, 412, and 414 are similar to the events 310A, 312A, and 314A, respectively. The UE 102 determines 417 that the first channel priority is equal to the second channel priority. In response, the UE 102 determines whether one or both of the channel configurations indicate that the UE 102 is to use SDT to transmit data for the associated channel. If so, then the UE 102 determines to use SDT to transmit the data for the channel(s) associated with SDT. In the scenario 400, the second channel is associated with SDT. Accordingly, the UE 102 determines to use SDT to transmit the second data. Similar to 322A, the UE 102 determines 422 whether to use CG-based SDT or RA-based SDT (i.e., using the techniques described with reference to 322B-D), and transmits 430 the second data using either CG-based SDT or RA-based SDT, depending on the outcome of the determination 422. At a later time, the UE 102 can use a legacy random access procedure to transmit the first data. If neither the first nor the second channel configuration indicate that the UE 102 is to use SDT, then the UE 102 performs a legacy random access procedure to transmit 440 the data, similar to the event 340A.

Similar to the scenario 300A, while the UE 102 detects pending data for two channels in the scenario 400, in other implementations, the UE 102 can detect pending data for more than two channels. In response, the UE 102 can apply similar techniques as those described for the scenario 400. In particular, if the UE 102 determines 419 that any of the channels for which the UE 102 detects pending data is associated with a channel configuration indicating that the UE 102 is to use SDT, then the UE 102 can select SDT for transmitting the pending data for those channels associated with SDT. Otherwise, the UE 102 can perform 440 a legacy random access procedure to transmit the pending data.

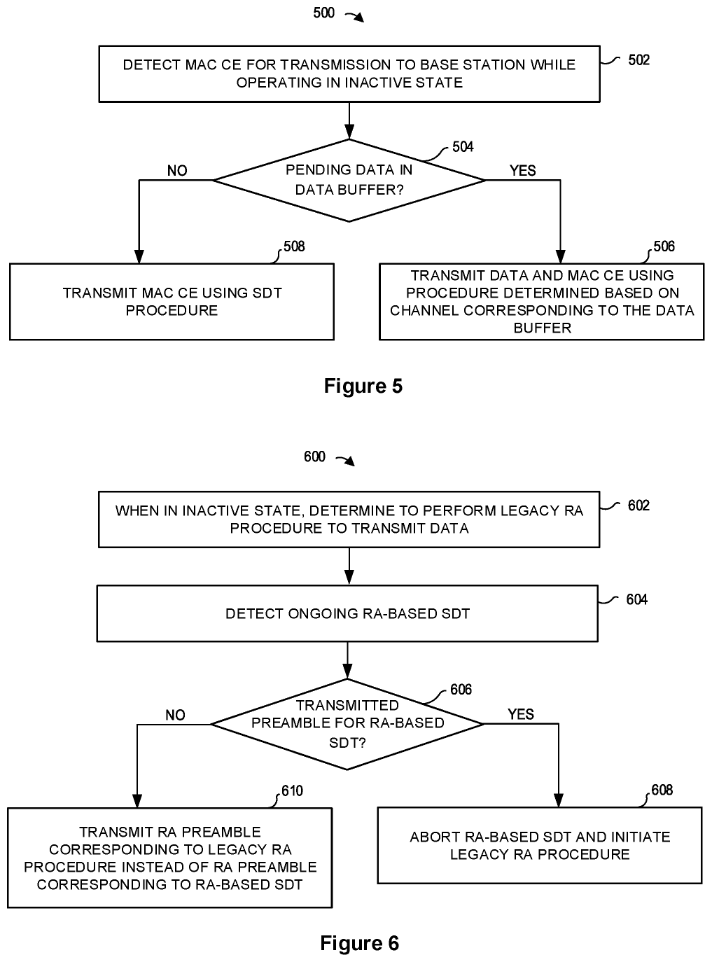

FIGS. 5-7 are flow diagrams of example methods that UE can implement to perform the techniques of this disclosure.

Turning to FIG. 5, a UE (e.g., the UE 102) can implement an example method 500 to transmit a medium access control (MAC) control element (CE) to a base station (e.g., the base station 104). At block 502, while the UE operates in an inactive state, the UE detects a MAC CE for transmission to the base station. At block 504, the UE determines whether there is pending data in a data buffer of the UE. If there is pending data in addition to the MAC CE, then the UE, at block 506, can transmit the pending data and the MAC CE to the base station using a procedure determined based on a channel corresponding to the data buffer. If there is pending data for more than one channel, then the UE can apply the techniques of FIGS. 3A-4 to determine which procedure to use for transmitting the data and the MAC CE. If there is not any pending data in the data buffer, then the UE, at block 508, transmits the MAC CE using an SDT procedure. The UE 102 can determine whether to use CG-based SDT or RA-based SDT using the techniques discussed with reference to FIGS. 3B-3D.

Turning to FIG. 6, a UE (e.g., the UE 102) can implement an example method 600 to transition from an RA-based SDT to a legacy random access procedure. At block 602, while operating in an inactive state, the UE determines to perform a legacy random access procedure to transmit data (e.g., because the UE detects data in a data buffer for the first channel). At block 604, the UE determines that the UE is already performing or has already determined to perform an RA-based SDT procedure. At block 606, the UE determines whether the UE has already transmitted a random access preamble for RA-based SDT (i.e., using the second type of random access resources). If so, then at block 608, the UE aborts the ongoing RA-based SDT procedure, and instead initiates a legacy random access procedure (i.e., by transmitting a preamble using the first type of random access resources). Otherwise, at block 610, the UE transmits a random access preamble corresponding to the legacy random access procedure instead of a random access preamble corresponding to the RA-based SDT.

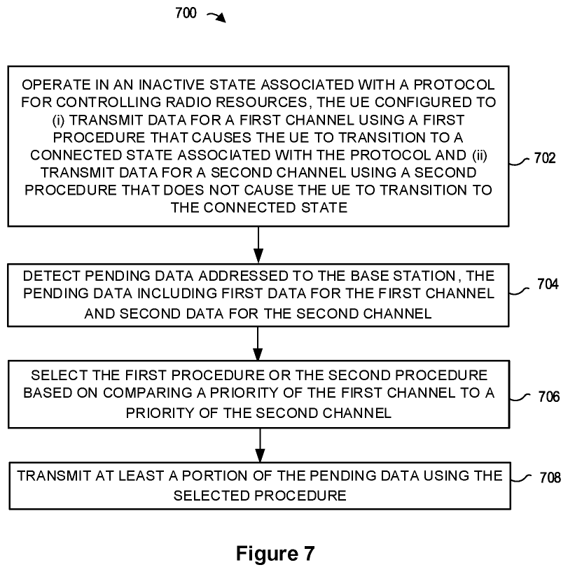

Referring to FIG. 7, a UE (e.g., the UE 102) can implement an example method 700 for communicating with a base station (e.g., the base station 104) when the UE operates in an inactive state associated with a protocol for controlling radio resources (e.g., RRC_INACTIVE). At block 702, the UE operates in the inactive state and is configured (i) to transmit data for a first channel using a first procedure that causes the UE to transition to a connected state associated with the protocol (e.g., a legacy random access procedure) and (ii) to transmit data for a second channel using a second procedure that does not cause the UE to transition to the connected state. The first channel is associated with a first priority and the second channel is associated with a second priority. For example, the UE can receive a first channel configuration for a first channel and a second channel configuration for a second channel (e.g., event 302A or similar events within procedures 310B-D, 410). Each channel configuration can indicate a priority of the channel and a procedure the UE should use to transmit data for the channel.

At block 704, the UE detects pending data addressed to the base station, the pending data including the first data for the first channel and the second data for the second channel (e.g., events 312A, 314A, 412, 414, or similar events within procedures 320B-D, 420). For example, the UE can detect the first data in a first data buffer associated with the first channel and the second data in a second data buffer associated with the second channel. At block 706, the UE selects the first procedure or the second procedure based on comparing a priority of the first channel to a priority of the second channel (e.g., events 315A, 419, or similar events within procedures 320B-D). If the priority of the second channel is above the priority of the first channel, the UE selects the second procedure (e.g., events 315A-318A, 320B-D). If the priority of the first channel is above the priority of the second channel, the UE selects the first procedure (e.g., events 315A-340A). If the priority of the second channel and the priority of the first channel are equal, the UE selects the second procedure (e.g., events 417-422). At block 708, the UE transmits at least a portion of the pending data using the selected procedure (e.g., 330A-D, 340, 440).

If the priority of the second channel is above the priority of the first channel, or if the priorities of the channels are equal, the UE 102 selects the second procedure and transmits the second data using the second procedure. The UE 102 can later transmit the first data using the first procedure. If the priority of the first channel is above the priority of the second channel, the UE 102 selects the first procedure and transmits both pending data, which can include both the first and second data, using the first procedure.

The second procedure may be an SDT procedure. If the UE selects the second procedure, then the UE can further select a type of the second procedure. In particular, the UE can determine whether to use a configured grant procedure (e.g., CG-based SDT) or a random access procedure (e.g., RA-based SDT) based on whether the UE is configured with a CG for a time period corresponding to the next transmission opportunity (e.g., during the remaining portion of a frame or subframe, or during a subsequent frame or subframe). If the UE has a CG for the time period, the UE can transmit the second data using the CG (e.g., event 330B). If the UE does not have a CG for the time period, in some implementations, the UE transmits the second data using another CG at a later time period after the time period (e.g., event 330C). In other implementations, the UE can initiate a random access procedure using a random access resource dedicated for use in the inactive state (e.g., the second type of random access resources), and transmit the second data using the random access procedure (e.g., event 330D).

The first procedure may be a legacy random access procedure. To transmit the pending data, the UE can initiate a random access procedure using a random access resource not dedicated for use in the inactive state (e.g., the first type of random access resources), and transmit the pending data during the random access procedure (e.g., events 340A, 440). In response to or during the random access procedure, the UE can transition to the connected state.

If the UE also detects a MAC CE addressed to the base station, the UE can transmit the MAC CE with the at least a portion of the pending data in the selected procedure (e.g., block 506).

Further, another aspect of this disclosure includes a method in a UE (e.g., the UE 102) for communicating with a base station (e.g., the base station 104) when the UE operates in an inactive state associated with a protocol for controlling radio resources. The method includes detecting a medium access control (MAC) control element (CE) addressed to the base station (e.g., block 502). The method also includes determining that the UE does not have pending data addressed to the base station (e.g., block 504). Further, the method includes, in response to the determining, transmitting the MAC CE to the base station without transitioning to a connected state associated with the protocol (e.g., block 508).

The following list of examples reflects a variety of the embodiments explicitly contemplated by the present disclosure:

Example 1. A method in a UE for communicating with a base station when the UE operates in an inactive state associated with a protocol for controlling radio resources, the UE configured (i) to transmit data for a first channel using a first procedure that causes the UE to transition to a connected state associated with the protocol and (ii) to transmit data for a second channel using a second procedure that does not cause the UE to transition to the connected state, the method comprising: detecting, by processing hardware of the UE, pending data addressed to the base station, the pending data including first data for the first channel and second data for the second channel; selecting, by the processing hardware, the first procedure or the second procedure based on comparing a priority of the first channel to a priority of the second channel; and transmitting, by the processing hardware, at least a portion of the pending data using the selected procedure.

Example 2. The method of example 1, wherein the selecting includes: if the priority of the second channel is above the priority of the first channel, selecting the second procedure.

Example 3. The method of example 1, wherein the selecting includes: if the priority of the first channel is equal to the priority of the second channel, selecting the second procedure.

Example 4. The method of example 2 or 3, wherein the at least a portion of the pending data is the second data.

Example 5. The method of any one of examples 2-4, wherein the transmitting includes: determining whether to transmit the at least a portion of the pending data using a configured grant procedure or a random access procedure based on whether the UE is configured with a configured grant for a time period corresponding to a next transmission opportunity.

Example 6. The method of example 5, wherein the transmitting includes: if the UE is configured with the configured grant for the time period, transmitting the at least a portion of the pending data using the configured grant.

Example 7. The method of example 5, wherein the transmitting includes: if the UE is not configured with the configured grant for the time period, transmitting the at least a portion of the pending data using another configured grant at a later time period after the time period.

Example 8. The method of example 5, wherein the transmitting includes: if the UE is not configured with the configured grant for the time period: initiating the random access procedure using a random access resource dedicated for use in the inactive state; and transmitting the at least a portion of the pending data during the random access procedure.

Example 9. The method of example 1, wherein the selecting includes: if the priority of the first channel is above the priority of the second channel, selecting the first procedure.

Example 10. The method of example 9, wherein the transmitting includes: initiating a random access procedure using a random access resource not dedicated for use in the inactive state; and transmitting the pending data during the random access procedure.

Example 11. The method of example 10, further comprising: in response to or during the random access procedure, transitioning, by the processing hardware, to the connected state.

Example 12. The method of any one of the preceding examples, wherein the second procedure is a small data transmission (SDT) procedure.

Example 13. The method of any one of the preceding examples, wherein detecting the pending data includes detecting the first data in a first data buffer associated with the first channel and detecting the second data in a second data buffer associated with the second channel.

Example 14. The method of any one of the preceding examples, further comprising: detecting a medium access control (MAC) control element (CE) addressed to the base station; and transmitting the MAC CE with the at least a portion of the pending data using the selected procedure.

Example 15. The method of any one of the preceding examples, further comprising: receiving, by the processing hardware from the base station, a configuration message prior to detecting the pending data.

Example 16. The method of example 15, wherein the configuration message includes first random access resources for the first procedure and second random access resources for the second procedure, the second random access resources dedicated for use in the inactive state.

Example 17. The method of example 15 or 16, wherein the configuration message includes the priority of the first channel and the priority of the second channel.

Example 18. The method of any one of examples 15-17, wherein the configuration message includes at least one configured grant.

Example 19. A user equipment (UE) including processing hardware and configured to implement a method according to any one of the preceding examples.

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method implemented in a UE for communicating with a base station the method comprising:
detecting, when the UE operates in an inactive state associated with a protocol for controlling radio resources, pending data addressed to the base station, the pending data including (i) first data for a first channel for which the UE is configured to use a first procedure that causes the UE to transition to a connected state associated with the protocol, and Iii) second data for a second channel for which the UE is configured to use a second procedure that causes the UE to remain in the inactive state;
selecting the first procedure or the second procedure based on comparing a priority of the first channel to a priority of the second channel; and
transmitting at least a portion of the pending data using the selected procedure.

2. The method of claim 1, wherein the selecting includes:
if the priority of the second channel is above the priority of the first channel, selecting the second procedure.

3. The method of claim 1, wherein the selecting includes:
if the priority of the first channel is equal to the priority of the second channel, selecting the second procedure.

4. The method of claim 2, wherein the at least a portion of the pending data is the second data.

5. The method of claim 2, wherein the transmitting includes:
determining whether to transmit the at least a portion of the pending data using a configured grant procedure or a random access procedure based on whether the UE is configured with a configured grant for a time period corresponding to a next transmission opportunity.

6. The method of claim 5, wherein the transmitting includes:
if the UE is configured with the configured grant for the time period, transmitting the at least a portion of the pending data using the configured grant.

7. The method of claim 5, wherein the transmitting includes:
if the UE is not configured with the configured grant for the time period, transmitting the at least a portion of the pending data using another configured grant at a later time period after the time period.

8. The method of claim 5, wherein the transmitting includes:
if the UE is not configured with the configured grant for the time period:
initiating the random access procedure using a random access resource dedicated for use in the inactive state; and
transmitting the at least a portion of the pending data during the random access procedure.

9. The method of claim 1, wherein the selecting includes:
if the priority of the first channel is above the priority of the second channel, selecting the first procedure.

10. The method of claim 9, wherein the transmitting includes:
initiating a random access procedure using a random access resource not dedicated for use in the inactive state; and
transmitting the pending data during the random access procedure.

11. The method of claim 1, wherein the second procedure is a small data transmission (SDT) procedure.

12. The method of claim 1, wherein the detecting of the pending data includes detecting the first data in a first data buffer associated with the first channel and detecting the second data in a second data buffer associated with the second channel.

13. The method of claim 1, further comprising:
detecting a medium access control (MAC) control element (CE) addressed to the base station; and
transmitting the MAC CE with the at least a portion of the pending data using the selected procedure.

14. The method of claim 1, further comprising:
receiving, from the base station, a configuration message prior to detecting the pending data.

15. The method of claim 14, wherein the configuration message includes the priority of the first channel and the priority of the second channel.

16. The method of claim 14, wherein the configuration message includes at least one configured grant.

17. A user equipment (UE) including processing hardware and configured to:
when the UE operates in an inactive state associated with a protocol for controlling radio resources, detect pending data addressed to a base station, the pending data including (i) first data for a first channel for which the UE is configured to use a first procedure that causes the UE to transition to a connected state associated with the protocol, and (ii) second data for a second channel for which the UE is configured to use a second procedure that causes the UE to remain in the inactive state;
select the first procedure or the second procedure based on comparing a priority of the first channel to a priority of the second channel; and
transmit at least a portion of the pending data using the selected procedure.

18. The UE of claim 17, further configured to:
determine whether to transmit the at least a portion of the pending data using a configured grant procedure or a random access procedure based on whether the UE is configured with a configured grant for a time period corresponding to a next transmission opportunity

19. The UE of claim 17, further configured to:
if the UE is configured with the configured grant for the time period, transmit the at least a portion of the pending data using the configured grant.

20. The UE of claim 17, further configured to:
if the UE is not configured with the configured grant for the time period, transmit the at least a portion of the pending data using another configured grant at a later time period after the time period.
